(19) United States
(12) Patent Application Publication
(10) Pub. No.: US 2026/0336722 A1
(43) Pub. Date: Oct. 29, 2026

(54) MAGNESIUM VEHICLE STRUCTURES AND METHOD FOR MANUFACTURING MAGNESIUM VEHICLE STRUCTURES

(71) Applicant: FCA US LLC, Auburn Hills, MI (US)

(72) Inventors: Abhishek PAUL, Auburn Hills, MI (US); Malli K. YALAMANCHILI, Auburn Hills, MI (US); Nitin SHARMA, Auburn Hills, MI (US); Randy GERKEN, Auburn Hills, MI (US)

(21) Appl. No.: 19/189,635

(22) Filed: Apr. 25, 2025

(51) Int. Cl. B62D 29/00; B62D 65/00; G06F 30/15; G06F 30/23; G06F 119/18

(52) U.S. Cl. CPC B62D 29/008; B62D 65/00; G06F 30/15; G06F 30/23; G06F 2119/18

(57) ABSTRACT

A method for manufacturing a vehicle structure formed from a magnesium alloy that may include designing at least one first vehicle underbody structural support that is formed from a magnesium alloy; designing at least one second vehicle underbody structural support that is formed from steel or aluminum; subjecting each of the first and second vehicle underbody structural supports to finite element analysis (FEA); determining whether the first vehicle underbody structural support exhibited characteristics similar to those of the second vehicle underbody structural support; and forming the first vehicle underbody structural support using a magnesium thixomolding process.

### FIELD

The present disclosure relates to magnesium vehicle structures, and to a method for manufacturing magnesium vehicle structures.

### BACKGROUND

This section provides background information related to the present disclosure which is not necessarily prior art.

Vehicles structures (e.g., frame) are typically formed from a rigid metal material such as steel. The use of steel to form the vehicle structures, however, can significantly increase a mass of the vehicle, which may be undesirable in vehicles that are electrically powered. In this regard, the increased mass requires increased energy to move the vehicle and the increased amount of energy that must be used to move the vehicle can have an adverse effect on the range of the vehicle.

With the above in mind, research has begun on alternative materials that can be used to form the structures of the vehicle that can reduce the mass of the vehicle and reduce the amount of energy that is required to move the vehicle. It should be understood, however, that steel cannot simply be replaced by an alternative material and the vehicle structure be expected to exhibit the same structural characteristics. Put another way, a vehicle structure formed from an alternative material cannot be expected to exhibit the same strength characteristics as a vehicle structure formed from steel, nor be expected to exhibit the same noise, vibration, and harshness (NVH) characteristics as a vehicle structure formed from steel. Thus, care needs to be taken when selecting a material for forming a vehicle structure that does not only take into consideration a reduction in mass to increase the battery life of an electric vehicle.

### SUMMARY

This section provides a general summary of the disclosure, and is not a comprehensive disclosure of its full scope or all of its features.

According to a first aspect of the present disclosure, there is provided a method for manufacturing a vehicle structure formed from a magnesium alloy that may include designing at least one first vehicle underbody structural support that is formed from a magnesium alloy; designing at least one second vehicle underbody structural support that is formed from steel or aluminum; subjecting each of the first and second vehicle underbody structural supports to finite element analysis (FEA); determining whether the first vehicle underbody structural support exhibited characteristics similar to those of the second vehicle underbody structural support; and forming the first vehicle underbody structural support using a magnesium thixomolding process.

According to the first aspect, the method may include, after determining whether the first vehicle underbody structural support exhibited characteristics similar to those of the second vehicle underbody structural support, modifying a design of the first vehicle underbody structural support to improve the characteristics thereof.

According to the first aspect, the FEA determines strength characteristics and vibrational characteristics of each of the first and second vehicle underbody structural supports.

According to the first aspect, if it is determined that at least one of the strength characteristics and the vibrational characteristics of the first vehicle underbody structural support are less than those exhibited by the second vehicle underbody structural support, the modifying the design of the first vehicle underbody structural support includes adding stiffening ribs to the first vehicle underbody structural support.

According to the first aspect, if it is determined that at least one of the strength characteristics and the vibrational characteristics of the first vehicle underbody structural support are less than those exhibited by the second vehicle underbody structural support, the modifying the design of the first vehicle underbody structural support includes enlarging a component of the first vehicle underbody structural support.

According to the first aspect, if it is determined that at least one of the strength characteristics and the vibrational characteristics of the first vehicle underbody structural support are less than those exhibited by the second vehicle underbody structural support, the modifying the design of the first vehicle underbody structural support includes enlarging a separate component that is used to connect the first vehicle underbody structural support to another component of the vehicle.

According to the first aspect, the forming the first vehicle underbody structural support using a magnesium thixomolding process includes a single-step, semi-solid molding process.

According to a second aspect, there is provided a vehicle structure manufactured according to the first aspect.

According to a third aspect of the present disclosure, there is provided a method for manufacturing a vehicle structure formed from a magnesium alloy that may include designing a first front vehicle underbody structural support that is formed from a magnesium alloy; designing a first rear vehicle underbody structural support that is formed from the magnesium alloy; designing a second front vehicle underbody structural support that is formed from steel or aluminum; designing a second rear vehicle underbody structural support that is formed from the steel or the aluminum; subjecting each of the first and second front vehicle underbody structural supports and each of the first and second rear vehicle underbody structural supports to finite element analysis (FEA); determining whether the first front vehicle underbody structural support and the first rear vehicle underbody structural support exhibited characteristics similar to those of the second front vehicle underbody structural support and the second rear vehicle underbody structural support, respectively; modifying a design of the first front vehicle underbody structural support and the first rear vehicle underbody structural support to improve the characteristics thereof; and forming the first front vehicle underbody structural support and the first rear vehicle underbody structural support using a magnesium thixomolding process.

According to the third aspect, the FEA determines strength characteristics and vibrational characteristics of each of the first and second front vehicle underbody structural supports, and each of the first and second rear vehicle underbody structural supports.

According to the third aspect if it is determined that at least one of the strength characteristics and the vibrational characteristics of the first front vehicle underbody structural support and the first rear vehicle underbody structural support are less than those exhibited by the second front vehicle underbody structural support and the second rear vehicle underbody structural support, respectively, the modifying the design of the first front vehicle underbody structural support and first rear vehicle underbody structural support includes at least adding stiffening ribs to the first front vehicle underbody structural support.

According to the third aspect if it is determined that at least one of the strength characteristics and the vibrational characteristics of the first rear vehicle underbody structural support are less than those exhibited by the second rear vehicle underbody structural support, the modifying the design of the first rear vehicle underbody structural support includes enlarging a component of the first rear vehicle underbody structural support.

According to the third aspect if it is determined that at least one of the strength characteristics and the vibrational characteristics of the first rear vehicle underbody structural support are less than those exhibited by the second rear vehicle underbody structural support, the modifying the design of the first rear vehicle underbody structural support includes enlarging a separate component that is used to connect the first rear vehicle underbody structural support to another component of the vehicle.

According to the third aspect the magnesium thixomolding process includes a single-step, semi-solid molding process.

According to a fourth aspect, there is provided a vehicle structure manufactured according to the third aspect.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is perspective view of an example vehicle including an underbody structure formed of a magnesium alloy according to a principle of the present disclosure;

FIG. 2 is a perspective view of an example front underbody structure formed of a magnesium alloy according to a principle of the present disclosure;

FIG. 3 is a perspective view of an example rear underbody structure formed of a magnesium alloy according to a principle of the present disclosure;

FIGS. 4A and 4B are side perspective views of a front underbody structure formed of a steel or aluminum;

FIG. 5 is a bottom perspective view of a rear underbody structure formed of a magnesium alloy according to a principle of the present disclosure;

FIG. 6 is a bottom perspective view of another example rear underbody structure formed of a steel or aluminum; and

FIG. 7 is a flow chart depicting an example method according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

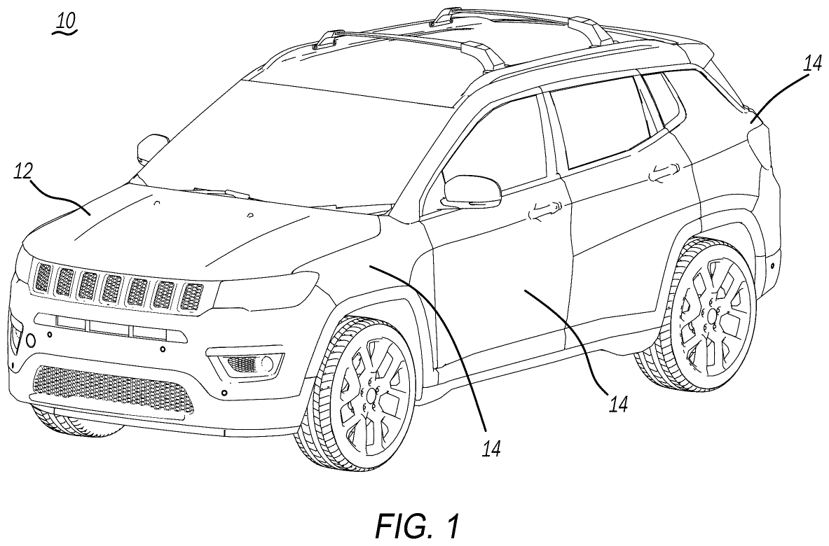

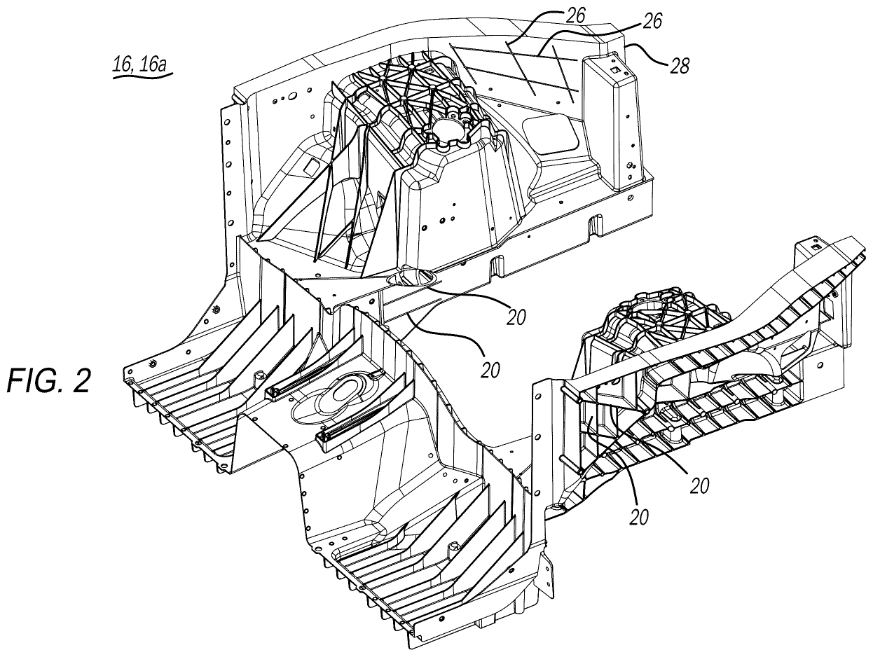

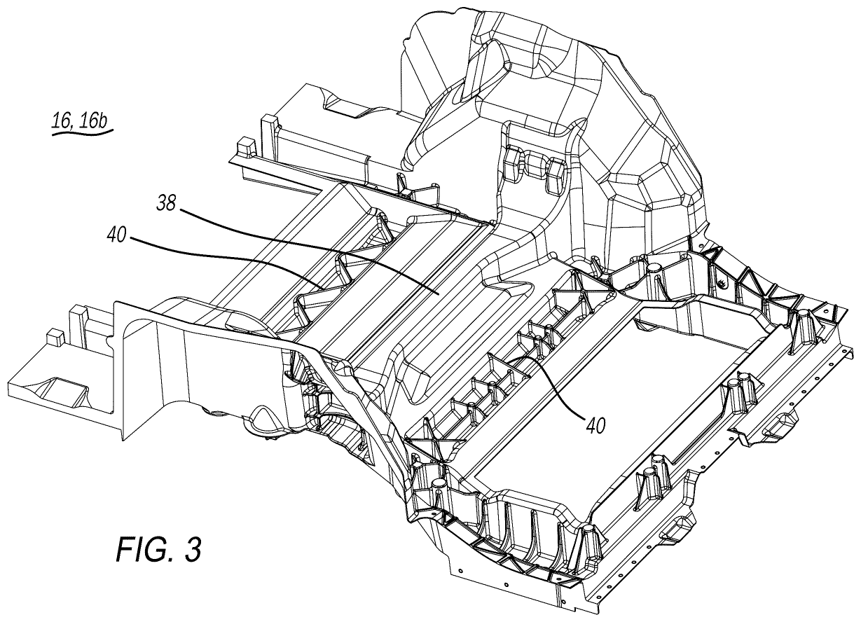

FIG. 1 illustrates an example vehicle 10 having a vehicle body 12 formed of various panels 14 that are attached to plurality of underbody structures 16 (FIGS. 2A and 3A) that are formed from a magnesium alloy using a thixomolding process. Thixomolding is a single-step, semi-solid molding process in which chips of the magnesium alloy are fed into a heated screw and barrel, then thermally and mechanically processed into a semi-solid state and injected into a tool cavity. The magnesium alloy exhibits a high strength-to-weight ratio and can be up to seventy-five percent lighter than steel, and up to thirty-three percent lighter than aluminum. The use of a magnesium alloy to form the underbody structures 16, therefore, can result in a significant reduction in mass associated with vehicle 10. The underbody structures 16 may include a front underbody structure 16a (FIG. 2) and a rear underbody structure 16b (FIG. 3).

The Young's modulus of magnesium alloys is about 42 GPa, which is less than that of steel (about 200 GPa) and aluminum (about 68 GPa). The underbody structures 16a and 16b, therefore, must have structural features that can permit the underbody structures 16a and 16b to exhibit strength characteristics that resemble those of a similar steel or aluminum structure, and also exhibit NVH characteristics that are similar to that of a similar steel or aluminum structure.

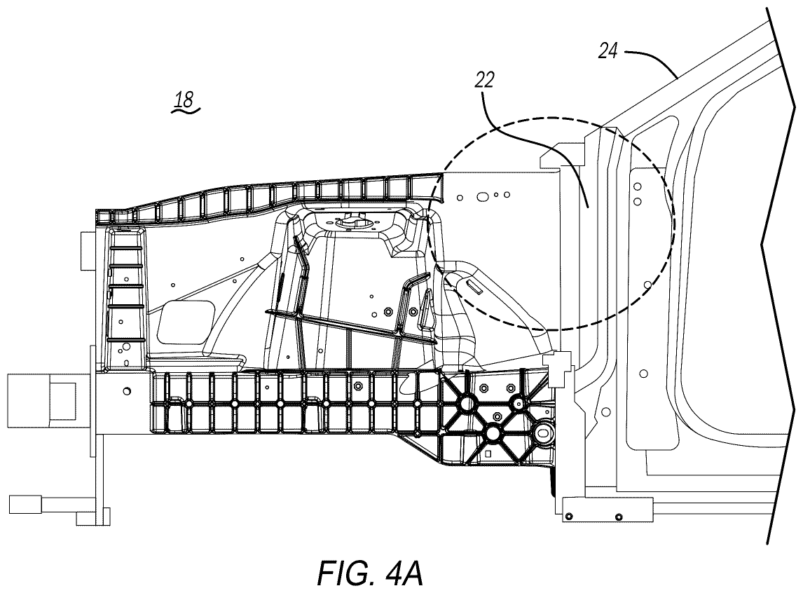

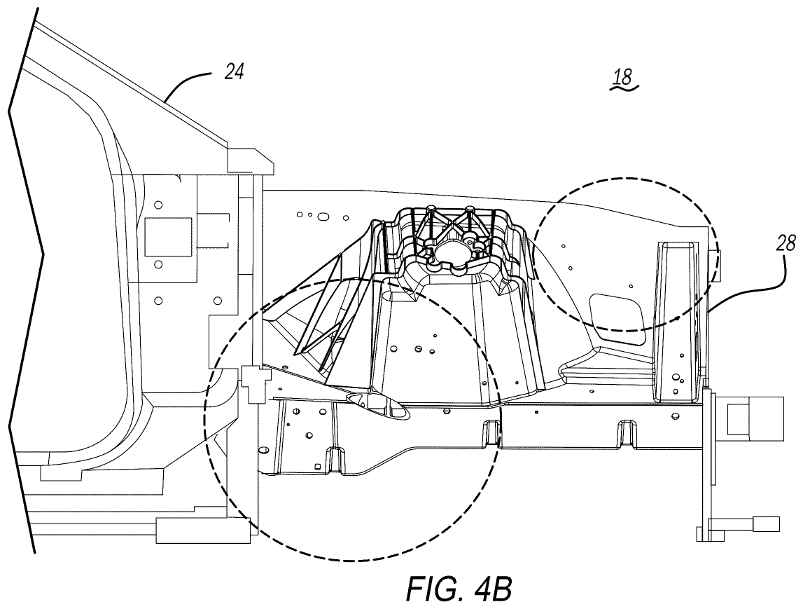

FIG. 2 illustrates an example front underbody structure 16a formed from a magnesium alloy, while FIGS. 4A and 4B illustrate an example front underbody structure 18 that is formed from a material such as steel. As can be seen in these figures, the Mg alloy front underbody structure 16a is very similar to the steel front underbody structure 18. After subjecting each of these example structures to finite element analysis (FEA), however, it was determined the Mg alloy front underbody structure 16a may be subject to more deformation during a collision event. The Mg alloy front underbody structure 16a, therefore, has been modified to include a plurality of first stiffening ribs 20 at locations proximate an interface between the Mg alloy front underbody structure 16a and an A-pillar 22 of a passenger compartment 24 of vehicle 10, and modified to include a plurality of second stiffening ribs 26 at a forward end 28 of the Mg alloy front underbody structure 16a to reduce an amount of crush that may be experienced by Mg alloy front underbody structure 16a during a frontal collision event. The ribs 20 and 26 are absent in the encircled areas of FIGS. 4A and 4B.

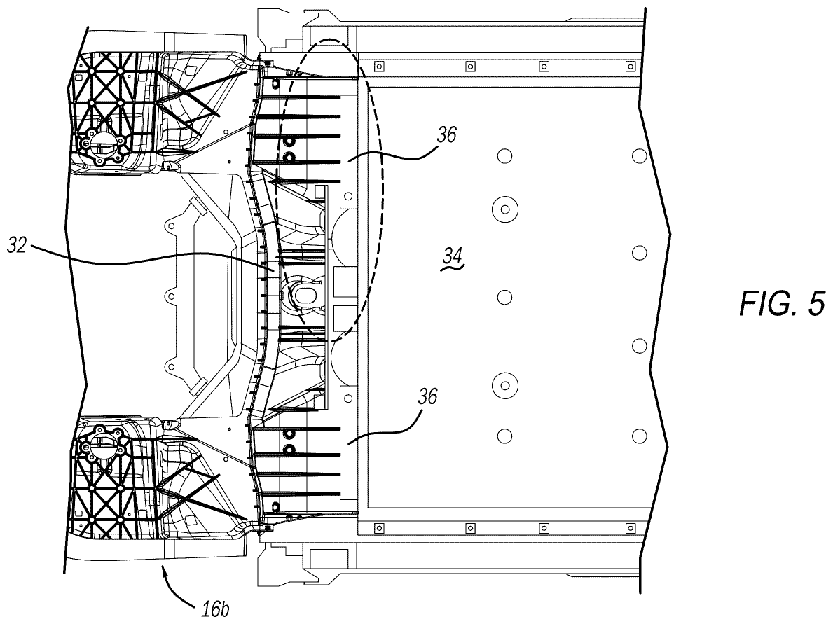

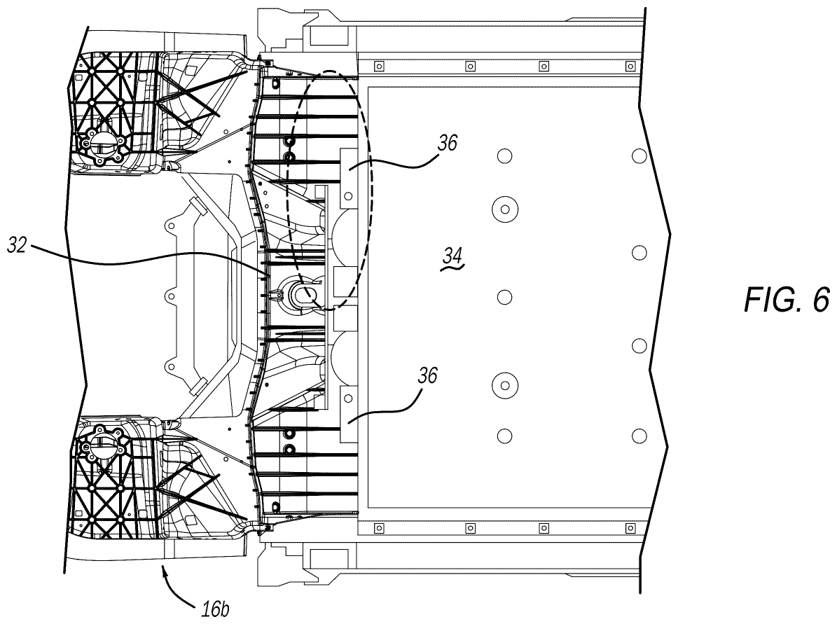

FIG. 5 illustrates another example rear underbody structure 16b formed from magnesium alloy and FIG. 6 illustrates an example rear underbody structure 30 that is formed form a material such as steel. As can be seen in these figures, the Mg alloy front underbody structure 16b is very similar to the steel rear underbody structure 30. After subjecting each of these example structures to finite element analysis (FEA), however, it was determined the Mg alloy rear underbody structure 16b may be subject to more deformation during a collision event. The Mg alloy rear underbody structure 16b, therefore, has been modified to include a wider cross-beam 32 at a location positioned aft of a battery pack 34 of vehicle 10. In addition, the FEA revealed the Mg alloy rear underbody structure 16b may experience more movement in a direction toward the battery pack 34 during a rear collision event in comparison to the steel rear underbody structure 30. Accordingly, the connection between the Mg rear underbody structure 16b and the battery pack 34 was strengthened by enlarging a size of a pair of connection plates 36 that are used to connect the Mg alloy rear underbody structure 16b and the battery pack 34.

While either of the rear underbody structures 16b that are shown in FIGS. 3 and 5 can be used, it should be understood that the rear underbody structure 16b illustrated in FIG. 3 may be preferable from the standpoint that connection plates 16 are not necessary to attach the rear underbody structure 16b to the cradle that supports battery pack 34 and increase the rigidity of the connection between the rear underbody structure 16b and the cradle that supports the battery pack 34. In this regard, the cross-beam 32 is omitted in FIG. 3 in favor of a more rigid structure 38 having strengthening baffles 40. Furthermore, it should be noted that with each of the underbody structures 16 shown in FIGS. 2, 3, and 5, the use of using magnesium thixomolding enables forming the entire front and rear underbody structures 16 as a single monolithic piece similar to gigacasting, which assists in reducing the assembly cost and complexity. Indeed, the assembly costs and complexity associated with forming steel structures can be much greater due to the requirement that front and rear frame structures are currently required to be formed of multiple pieces/parts (while FIGS. 4A and 4B show a front underbody structure 18 formed 18 formed of steel, it should be understood that this was done using computer aided engineering to simply provide a basis for structural and NVH comparison with the Mg underbody structures according to the present disclosure).

While the Mg alloy front and rear underbody structures 16a and 16b have been modified to increase the strength exhibited during collision events to behave in a manner similar to the steel front and rear underbody structures 18 and 30, it should also be understood that when the Mg alloy front and rear underbody structures 16a and 16b are subjected to NVH testing, the Mg alloy front and rear underbody structures 16a and 16b functioned in a manner that is substantially the same as the steel front and rear underbody structures 18 and 30. Indeed, as can be seen in the below Table 1, when targeting a first mode vibration (bending) of 26.0 Hz and when targeting a second mode vibration (torsion) of 27.0 Hz, each of the steel structures and the Mg alloy structures exceeded the target. Thus, even when vehicle 10 includes front and rear underbody structures 16a and 16b that are formed from a magnesium alloy, no sacrifice is made with respect to NVH characteristics.

TABLE 1

| | BIW Target | Steel | Mg | Difference |
|---|---|---|---|---|
| Mode Description | (Hz) | (Hz) | (Hz) | (Hz) |
| First Mode (bending) | 26 | 29.4 | 29.1 | 3.1 |
| Second Mode (torsion) | 27 | 30.4 | 30.4 | 3.4 |

The Mg alloy front and rear underbody structures 16a and 16b also exhibit satisfactory NVH characteristics when a body-in-white including these structures is provided with suspension components and subjected to vibration testing, as shown by the below Tables 2-4.

TABLE 2

| | | | Target | | Steel | | Mg | |
|---|---|---|---|---|---|---|---|---|
| | | | Summary [kN/mm] | | Summary [kN/mm] | | Summary [kN/mm] | |
| | | | 8-200 | 200-300 | 80-200 | 200-300 | 80-200 | 200-300 |
| Location | Mount | DIR | Hz | Hz | Hz | Hz | Hz | Hz |
| Front | Front | X | 20 | 40 | 17.6 | 24.2 | 18.5 | 27 |
| Suspension | Lower | Y | 20 | 25 | 19.1 | 58.2 | 19.1 | 63 |
| | Control Arm | Z | 20 | 46 | 32 | 38.1 | 26.4 | 61.1 |
| | Rear | X | 20 | 40 | 19.7 | 23.9 | 18.5 | 25.6 |
| | Lower | Y | 20 | 62 | 21 | 47 | 25.8 | 45.3 |
| | Control Arm | Z | 20 | 25 | 18.7 | 17.3 | 18.7 | 19.3 |

TABLE 3

| | | | Target | | Steel | | Mg | |
|---|---|---|---|---|---|---|---|---|
| | | | Summary [kN/mm] | | Summary [kN/mm] | | Summary [kN/mm] | |
| | | | 8-200 | 200-300 | 80-200 | 200-300 | 80-200 | 200-300 |
| Location | Mount | DIR | Hz | Hz | Hz | Hz | Hz | Hz |
| Front | UCA Front | X | 6 | 6 | 6.6 | 6.1 | 17.4 | 20.3 |
| Suspension | | Y | 10 | 15 | 15.8 | 15.2 | 15.4 | 21.4 |
| | | Z | 20 | 32 | 22.8 | 27.4 | 23.8 | 27.3 |
| | UCA Rear | X | 10 | 10 | 7.5 | 7.5 | 33.2 | 42.7 |
| | | Y | 20 | 25 | 17.1 | 14 | 27 | 47.6 |
| | | Z | 30 | 35 | 19.5 | 18.5 | 37.8 | 32.6 |
| | Shock | X | 15 | 20 | 15.5 | 13.7 | 24.6 | 26 |
| | Absorber | Y | 15 | 25 | 14.3 | 33.1 | 12 | 22.5 |
| | | Z | 30 | 35 | 16.3 | 16.7 | 22.6 | 20.5 |

TABLE 4

| | | | Target | | Steel | | Mg | |
|---|---|---|---|---|---|---|---|---|
| | | | Summary [kN/mm] | | Summary [kN/mm] | | Summary [kN/mm] | |
| | | | 8-200 | 200-300 | 80-200 | 200-300 | 80-200 | 200-300 |
| Location | Mount | DIR | Hz | Hz | Hz | Hz | Hz | Hz |
| Rear | Shock | X | 10 | 32 | 28.7 | 47.3 | 24.1 | 32.5 |
| Suspension | Absorber | Y | 15 | 15 | 7.3 | 6.2 | 18.8 | 33.4 |
| | | Z | 18 | 32 | 15.6 | 24.4 | 23.5 | 33.1 |
| | Rear | X | 16 | 35 | 51.8 | 50.8 | 75.4 | 72.3 |
| | Subframe | Y | 32 | 32 | 28 | 36.8 | 39.6 | 43.6 |
| | Front | Z | 10 | 40 | 16.6 | 24.9 | 28.8 | 42.5 |
| | Rear | X | 14 | 14 | 12.9 | 16.6 | 17.1 | 49 |
| | Subframe | Y | 24 | 32 | 19.6 | 24 | 22.3 | 40.1 |
| | Rear | Z | 10 | 27 | 15.7 | 17.5 | 20.6 | 42.7 |

Indeed, as can be seen in the above Tables 2-4, it can be seen that the vibration characteristics of a body-in-white structure subjected to vibration testing actually had vibration characteristics that exceeded those of a body-in-white structure that includes front and rear underbody structures 18 and 30 that were formed from steel. Thus, even when vehicle 10 includes front and rear underbody structures 16a and 16b that are formed from a magnesium alloy, better performance with respect to NVH characteristics can be achieved.

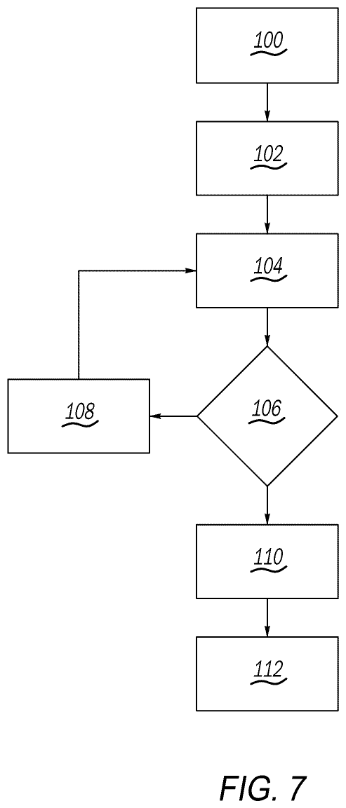

A method for generating a body-in-white structure formed from a magnesium alloy will now be described, with reference to FIG. 7. In a first step (step 100), a Mg front underbody structure 16a and a Mg rear underbody structure 16b are developed and designed using computer-aided engineering techniques. Then, in a second step 102, a steel or aluminum front underbody structure 18 and a steel or aluminum rear underbody structure 30 are developed and designed using the computer-aided engineering techniques. The structures that are developed and designed in steps 100 and 102 are the same, with the exception of the material.

Then, in step 104, the structures developed and designed in steps 100 and 102 are subjected to FEA to study strength and NVH characteristics and it is determined (step 106) whether the Mg front and rear underbody structures 16a and 16b exhibit characteristics similar to those exhibited by the steel or aluminum underbody structures 18 and 30. If no, the method proceeds to step 108 where the Mg front and rear underbody structures 16a and 16b are modified to increase the strength and/or NVH characteristics, before returning to step 104 to determine whether the modified Mg front and rear underbody structures 16a and 16b exhibit characteristics similar to those exhibited by the steel or aluminum underbody structures 18 and 30. If yes, the method proceeds to step 110 where the Mg front and rear underbody structures 16a and 16b can be manufactured using a thixomolding process before being incorporated into vehicle 10 (step 112), where the method ends.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for manufacturing a vehicle structure formed from a magnesium alloy, the method comprising:
designing at least one first vehicle underbody structural support that is formed from a magnesium alloy;
designing at least one second vehicle underbody structural support that is formed from steel or aluminum;
subjecting each of the first and second vehicle underbody structural supports to finite element analysis (FEA);
determining whether the first vehicle underbody structural support exhibited characteristics similar to those of the second vehicle underbody structural support; and
forming the first vehicle underbody structural support using a magnesium thixomolding process.

2. The method according to claim 1, further comprising after determining whether the first vehicle underbody structural support exhibited characteristics similar to those of the second vehicle underbody structural support, modifying a design of the first vehicle underbody structural support to improve the characteristics thereof.

3. The method according to claim 2, wherein the FEA determines strength characteristics and vibrational characteristics of each of the first and second vehicle underbody structural supports.

4. The method according to claim 3, wherein if it is determined that at least one of the strength characteristics and the vibrational characteristics of the first vehicle underbody structural support are less than those exhibited by the second vehicle underbody structural support, the modifying the design of the first vehicle underbody structural support includes adding stiffening ribs to the first vehicle underbody structural support.

5. The method according to claim 3, wherein if it is determined that at least one of the strength characteristics and the vibrational characteristics of the first vehicle underbody structural support are less than those exhibited by the second vehicle underbody structural support, the modifying the design of the first vehicle underbody structural support includes enlarging a component of the first vehicle underbody structural support.

6. The method according to claim 3, wherein if it is determined that at least one of the strength characteristics and the vibrational characteristics of the first vehicle underbody structural support are less than those exhibited by the second vehicle underbody structural support, the modifying the design of the first vehicle underbody structural support includes enlarging a separate component that is used to connect the first vehicle underbody structural support to another component of the vehicle.

7. The method according to claim 1, wherein the forming the first vehicle underbody structural support using a magnesium thixomolding process includes a single-step, semi-solid molding process.

8. A vehicle structure manufactured according to the method of claim 1.

9. A method for manufacturing a vehicle structure formed from a magnesium alloy, the method comprising:
designing a first front vehicle underbody structural support that is formed from a magnesium alloy;
designing a first rear vehicle underbody structural support that is formed from the magnesium alloy;
designing a second front vehicle underbody structural support that is formed from steel or aluminum;
designing a second rear vehicle underbody structural support that is formed from the steel or the aluminum;
subjecting each of the first and second front vehicle underbody structural supports and each of the first and second rear vehicle underbody structural supports to finite element analysis (FEA);
determining whether the first front vehicle underbody structural support and the first rear vehicle underbody structural support exhibited characteristics similar to those of the second front vehicle underbody structural support and the second rear vehicle underbody structural support, respectively;
modifying a design of the first front vehicle underbody structural support and the first rear vehicle underbody structural support to improve the characteristics thereof; and
forming the first front vehicle underbody structural support and the first rear vehicle underbody structural support using a magnesium thixomolding process.

10. The method according to claim 9, wherein the FEA determines strength characteristics and vibrational characteristics of each of the first and second front vehicle underbody structural supports, and each of the first and second rear vehicle underbody structural supports.

11. The method according to claim 10, wherein if it is determined that at least one of the strength characteristics and the vibrational characteristics of the first front vehicle underbody structural support and the first rear vehicle underbody structural support are less than those exhibited by the second front vehicle underbody structural support and the second rear vehicle underbody structural support, respectively, the modifying the design of the first front vehicle underbody structural support and first rear vehicle underbody structural support includes at least adding stiffening ribs to the first front vehicle underbody structural support.

12. The method according to claim 11, wherein if it is determined that at least one of the strength characteristics and the vibrational characteristics of the first rear vehicle underbody structural support are less than those exhibited by the second rear vehicle underbody structural support, the modifying the design of the first rear vehicle underbody structural support includes enlarging a component of the first rear vehicle underbody structural support.

13. The method according to claim 11, wherein if it is determined that at least one of the strength characteristics and the vibrational characteristics of the first rear vehicle underbody structural support are less than those exhibited by the second rear vehicle underbody structural support, the modifying the design of the first rear vehicle underbody structural support includes enlarging a separate component that is used to connect the first rear vehicle underbody structural support to another component of the vehicle.

14. The method according to claim 9, wherein the magnesium thixomolding process includes a single-step, semi-solid molding process.

15. A vehicle structure manufactured according to the method of claim 9.
